(19) United States
(12) Patent Application Publication
(10) Pub. No.: US 2015/0008690 A1
(43) Pub. Date: Jan. 8, 2015

(54) SUCTION STRUCTURE, ROBOT HAND AND ROBOT

(71) Applicant: KABUSHIKI KAISHA YASKAWA DENKI, Kitakyushu-shi (JP)

(72) Inventor: Shinichi KOBUCHI, Fukuoka (JP)

(73) Assignee: KABUSHIKI KAISHA YASKAWA DENKI, Kitakyushu-shi (JP)

(21) Appl. No.: 14/325,267

(22) Filed: Jul. 7, 2014

(30) Foreign Application Priority Data
Jul. 8, 2013 (JP) 2013-142870

(51) Int. Cl. B25J 15/06

(52) U.S. Cl. CPC B25J 15/0616; B25J 15/0683; Y10S 901/40
USPC 294/183; 901/40

(57) ABSTRACT

A suction structure includes a fixing base, a pad, and a support body. The fixing base includes an annular wall portion. The pad includes a contact portion which makes contact with a target object to be sucked. The support body is installed on an inner circumferential surface of the annular wall portion, and the support body is configured to elastically support an outer circumferential surface of the pad at a lateral side of the pad. Further, the pad and the support body define an inner space, and the fixing base includes a suction hole which brings the inner space into communication with a vacuum source.

### CROSS-REFERENCE TO RELATED APPLICATION

The present disclosure contains subject matter related to that disclosed in Japanese Priority Patent Application No. 2013-142870 filed with the Japan Patent Office on Jul. 8, 2013, the entire contents of which are incorporated herein by reference.

### BACKGROUND OF THE INVENTION

1. Field of the Invention

Embodiments disclosed herein relate to a suction structure, a robot hand and a robot.

2. Description of the Related Art

In the related art, there is known a substrate transfer robot that transfers a thin substrate such as a wafer or a glass substrate (see, e.g., Japanese Patent Application Publication No 2008-28134).

The robot includes, e.g., an arm and a robot hand (hereinafter referred to as a “hand”) installed to a leading end portion of the arm. The robot transfers a substrate by operating the arm in a horizontal direction and other directions, while causing the hand to hold the substrate.

In the course of transferring the substrate, it is necessary to reliably hold the substrate and to prevent position shift of the substrate. Thus, there is proposed a robot which includes a hand having a suction structure using a vacuum pad or the like and which holds a substrate during the transfer thereof by causing the suction structure to suck the substrate.

If the robot is used in a semiconductor manufacturing process, a substrate undergoes a thermal treatment process such as a film formation process or the like. Therefore, the robot often transfers a substrate heated to a high temperature in the thermal treatment process.

### SUMMARY OF THE INVENTION

In accordance with an aspect of the embodiment, a suction structure including: a fixing base including an annular wall portion; a pad including a contact portion which makes contact with a target object to be sucked; and a support body, which is installed on an inner circumferential surface of the annular wall portion and configured to elastically support an outer circumferential surface of the pad at a lateral side of the pad. The pad and the support body define an inner space, and the fixing base includes a suction hole which brings the inner space into communication with a vacuum source.

### BRIEF DESCRIPTION OF THE DRAWINGS

FIG. 1 is a schematic perspective view of a robot according to a first embodiment.

FIG. 2 is a schematic plan view of a hand according to the first embodiment.

FIG. 3A is a schematic plan view of a pad according to the first embodiment.

FIG. 3B is a schematic sectional view taken along line IIIB-IIIB′ in FIG. 3A.

FIG. 3C is a schematic diagram illustrating the flexibility of the pad according to the first embodiment.

FIG. 3D is a schematic perspective view of a support body according to the first embodiment.

FIG. 3E is a schematic sectional view showing an attachment structure of the pad according to the first embodiment before the pad is fixed to a fixing base.

FIG. 3F is a schematic sectional view showing the attachment structure of the pad according to the first embodiment after the pad is fixed to the fixing base.

FIG. 3G is a schematic plan view showing an arrangement example of the pad according to the first embodiment.

FIGS. 4A to 4D are schematic diagrams showing the movement of the pad according to the first embodiment.

FIG. 5A is a schematic plan view of a pad according to a second embodiment.

FIG. 5B is a schematic sectional view taken along line VB-VB′ in FIG. 5A.

FIGS. 6A to 6D are schematic diagrams showing the movement of the pad according to the second embodiment.

FIG. 7A is a schematic plan view of a support body according to a first modified example.

FIG. 7B is a schematic plan view of a support body according to a second modified example.

FIG. 8A is a schematic plan view of a pad according to a third embodiment.

FIG. 8B is a schematic sectional view taken along line VIIIB-VIIIB′ in FIG. 8A when the pad according to the third embodiment is fixed to the fixing base.

FIG. 8C is a schematic sectional view taken along line VIIIB-VIIIB′ in FIG. 8A when a pad according to a modified example of the third embodiment is fixed to the fixing base.

FIG. 9 is a schematic plan view of a pad according to another modified example of the third embodiment.

FIG. 10 is a schematic diagram showing elastic bonding layers.

### DESCRIPTION OF THE EMBODIMENTS

Embodiments of a suction structure, a robot hand and a robot will now be described in detail with reference to the accompanying drawings. The present disclosure is not limited to the embodiments.

Hereinafter, description will be made by taking, as an example, a case where the robot is a substrate transfer robot for transferring a wafer as a target object. The wafer is designated by reference symbol “W”. In the following description, each of the rigid elements which constitute a mechanical structure and which can make movement relative to each other will be referred to as a “link”. The “link” will be often referred to as an “arm”.

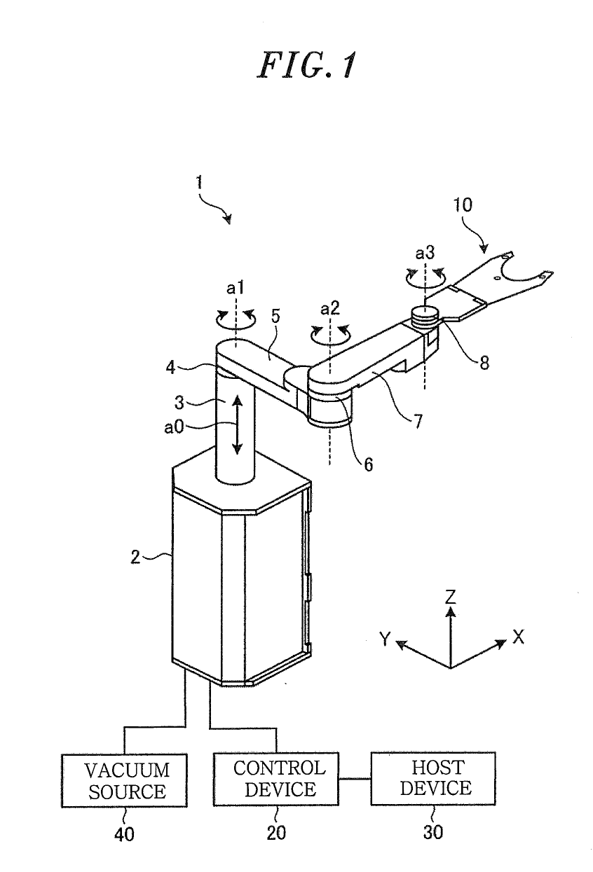

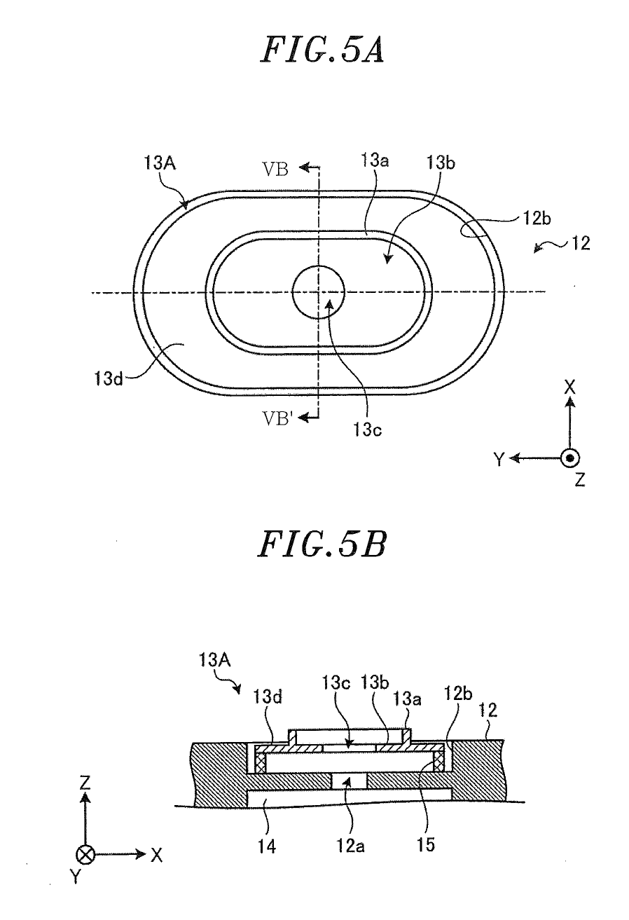

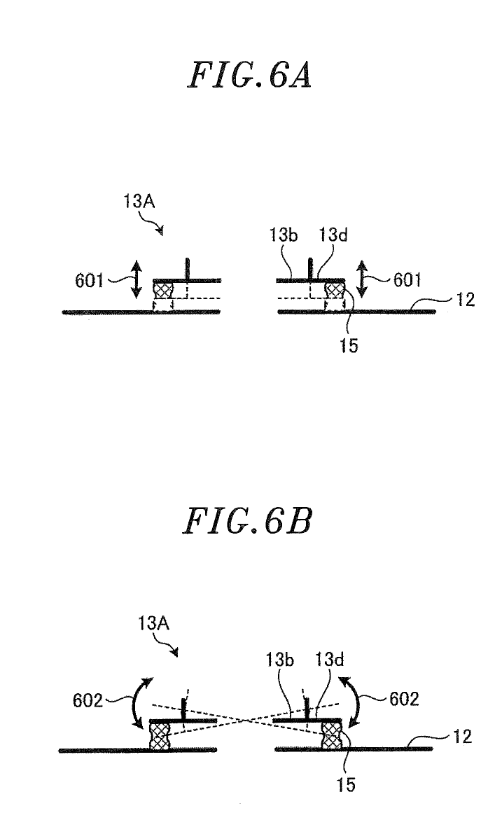

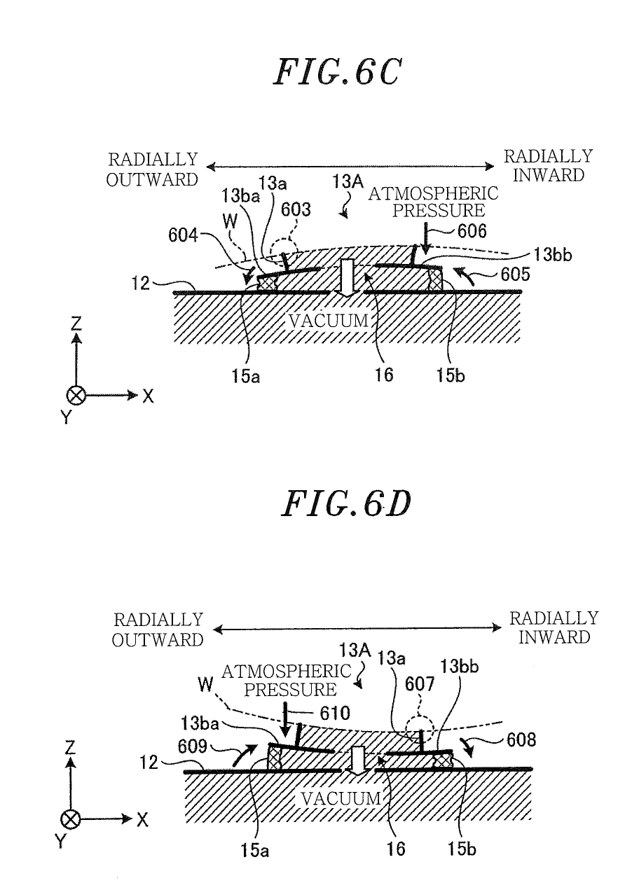

Description made with reference to FIGS. 1 to 4D is directed to a first embodiment which takes, as an example, a case where a pad is elastically supported from the bottom at a portion around the periphery of a suction hole. Description made with reference to FIGS. 5A to 6D is directed to a second embodiment which takes, as an example, a case where a pad is elastically supported from the bottom at a portion around the outer periphery of the pad itself.

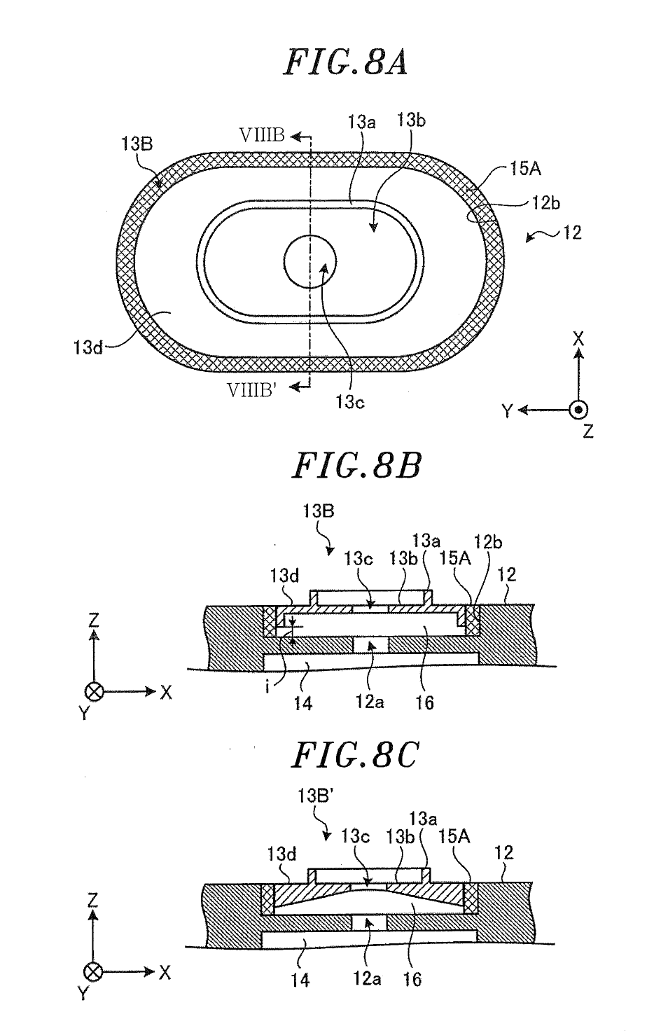

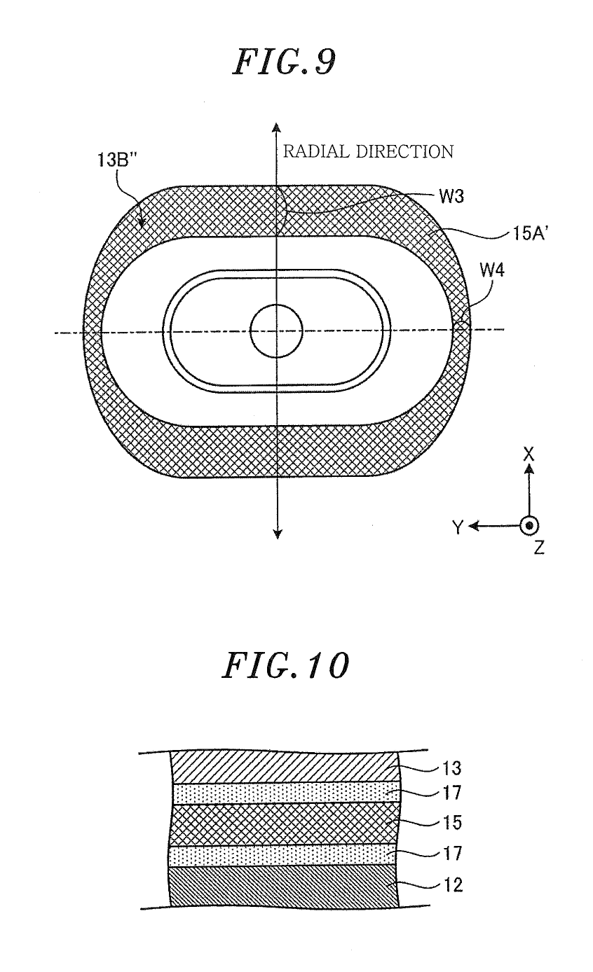

Description made with reference to FIGS. 8A to 9 is directed to a third embodiment which takes, as an example, a case where a pad is elastically supported at the lateral side thereof. Description made with reference to the other drawings is directed to certain modified examples.

### First Embodiment

First, the configuration of a robot 1 according to the first embodiment will be described with reference to FIG. 1. FIG. 1 is a schematic perspective view of the robot 1 according to the first embodiment.

For the sake of easy understanding, a three-dimensional rectangular coordinate system including a Z-axis whose positive direction extend vertically upward and whose negative direction extends vertically downward is indicated in FIG. 1. The direction extending along an X-Y plane designates a “horizontal direction”. This rectangular coordinate system is sometimes indicated in other drawings used in the following description.

In the following description, for the purpose of convenience in description, the positional relationship between the respective parts of the robot 1 will be described under the assumption that the swing position of the robot 1 and the orientation thereof are in the states shown in FIG. 1.

In the following description, it is sometimes the case that, with respect to a plurality of components, some are designated by reference symbols with the others not given any reference symbol. In this case, it is assumed that some of the components designated by the reference symbols are identical in configuration with the rest of the components.

As shown in FIG. 1, the robot 1 includes a base 2, a lifting and lowering unit 3, and an arm unit having a first joint unit 4, a first arm 5, a second joint unit 6, a second arm 7, a third joint unit 8 and a hand 10.

The base 2 is a base unit of the robot 1 and is fixed to a floor surface or a wall surface. In some case, the robot 1 is fixed to another device by using the upper surface of the base 2. The lifting and lowering unit 3 is installed so that it can slide in a vertical direction (a Z-axis direction) with respect to the base 2 (see a double-head arrow a0 in FIG. 1). The lifting and lowering unit 3 moves the arm unit of the robot 1 up and down along the vertical direction.

The first joint unit 4 is a rotary joint rotatable about an axis a1. The first arm 5 is rotatably connected to the lifting and lowering unit 3 through the first joint unit 4 (see a double-head arrow around the axis a1 in FIG. 1).

The second joint unit 6 is a rotary joint rotatable about an axis a2. The second arm 7 is rotatably connected to the first arm 5 through the second joint unit 6 (see a double-head arrow around the axis a2 in FIG. 1).

The third joint unit 8 is a rotary joint rotatable about an axis a3. The hand 10 is rotatably connected to the second arm 7 through the third joint unit 8 (see a double-head arrow around the axis a3 in FIG. 1). The robot 1 is equipped with a drive source (not shown) such as a motor or the like. Each of the first joint unit 4, the second joint unit 6 and the third joint unit 8 is rotated by the operation of the drive source.

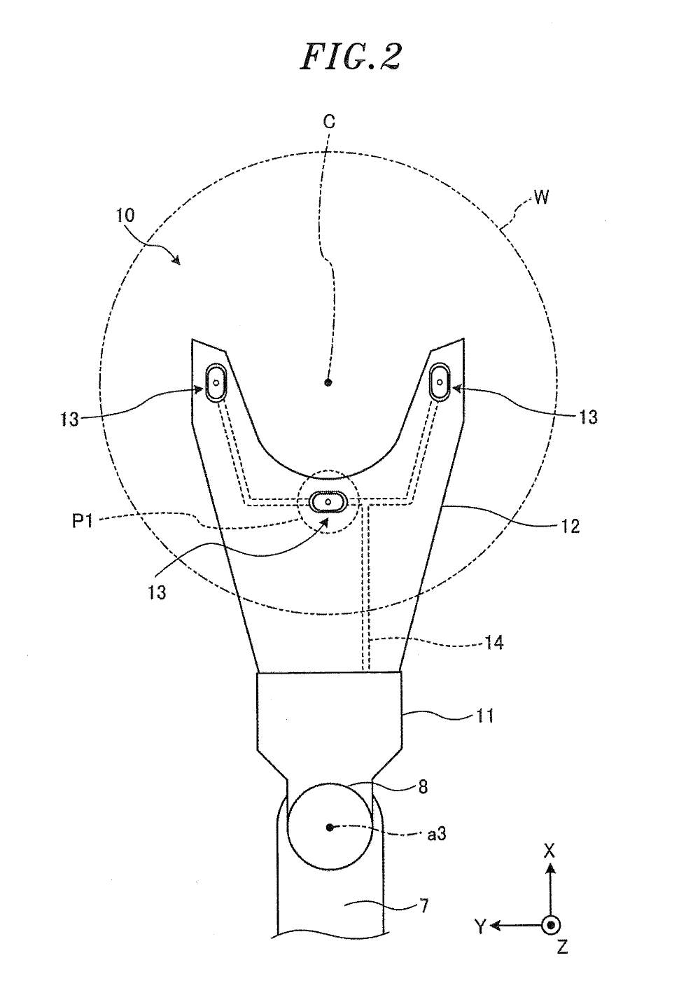

The hand 10 is an end effector that vacuum-sucks and holds a wafer W. Details of the configuration of the hand 10 will be described later with reference to FIG. 2 and the following figures. In FIG. 1, there is shown a case where the robot 1 is provided with one hand 10. However, the number of the hand 10 is not limited thereto.

For example, a plurality of hands 10 may be installed in an overlapping relationship to have the axis a3 as a rotation axis so that the hands 10 can independently rotate about the axis a3.

The robot 1 transfers a wafer W with the combination of the up/down operation of the lifting and lowering unit 3 and the rotating operations of the respective arms 5 and 7 and the hand 10. These operations are performed by the instructions from a control device 20 which is connected to the robot 1 through a communication network so that they can make communication with each other.

The control device 20 is a controller that control the operation of the robot 1. For instance, the control device instructs the operation of the aforementioned drive source. Responsive to the instruction transmitted from the control device 20, the robot 1 rotates the drive source by an arbitrary angle, thereby rotating the arm unit.

This operation control is performed based on the teaching data stored in the control device 20 in advance. However, there may be a case where teaching data are obtained from a host device 30 connected to the control device 20 so that they can make communication with each other.

Next, the configuration of the hand 10 will be described with reference to FIG. 2. FIG. 2 is a schematic plan view of the hand 10 according to the first embodiment. In FIG. 2, the wafer W in a normal position is indicated by a double-dot chain line. In this regard, the normal position refers to a position where the wafer is ideally located on the hand 10. In the following description, the center of the wafer W in the normal position will be designated by reference symbol “C”.

As shown in FIG. 2, the hand 10 is installed to the leading end portion of the second arm 7 through the third joint unit 8 so as to rotate about the axis a3. The hand 10 includes a plate holder 11, a plate 12, pads 13 and a vacuum path 14.

The plate holder 11 is connected to the third joint unit 8 and is configured to support the plate 12. The plate 12 is a member serving as a base of the hand 10 and is made of ceramic or the like. In FIG. 2, there is illustrated the plate 12 whose leading end portion has a bifurcated shape, but the shape of the plate 12 is not limited thereto.

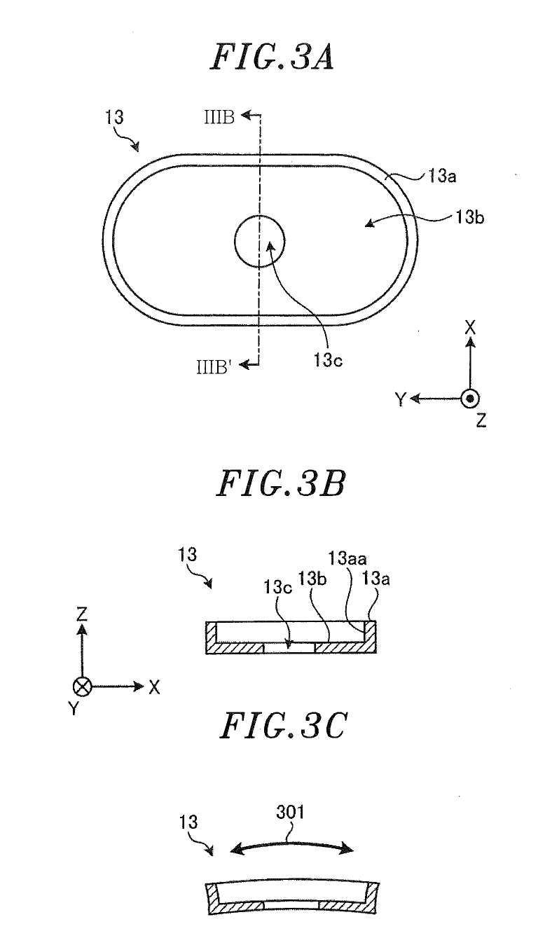

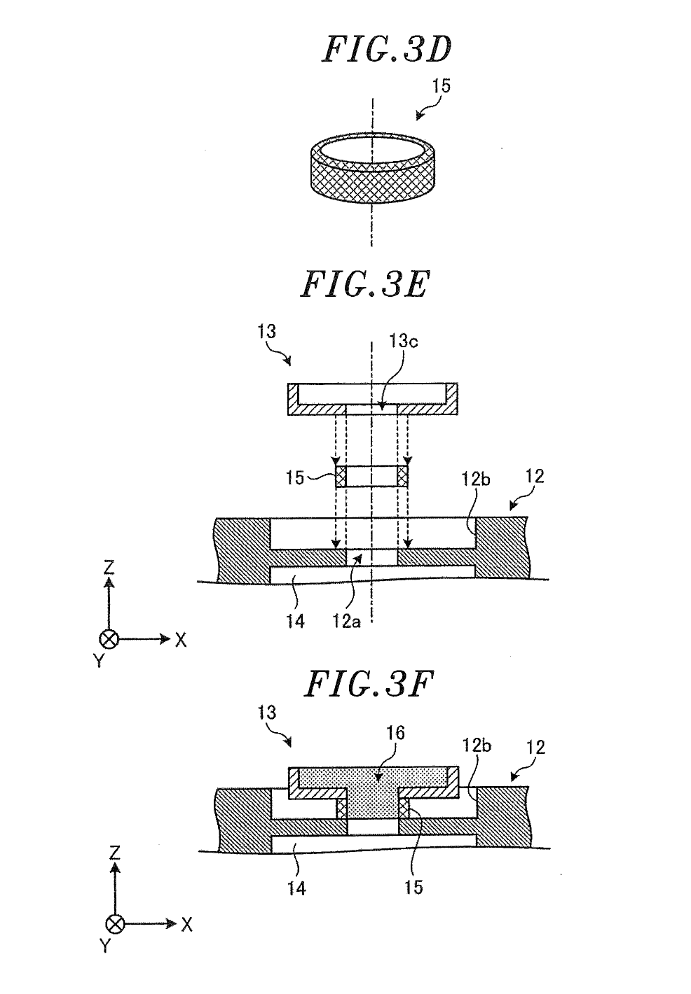

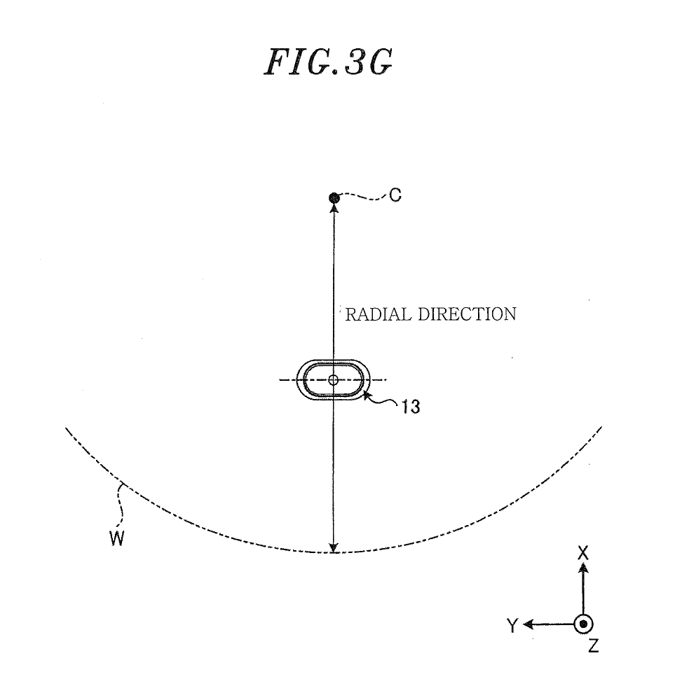

The pads 13 are members that vacuum-suck the wafer W to hold the wafer W on the hand 10. In the present embodiment, three pads 13 are installed in the positions shown in FIG. 2 and are configured to suck and hold the wafer W at three points. The number of the pads 13 is not limited to three and may be, e.g., more than three. As shown in FIG. 2, each of the pads 13 is formed into, e.g., a substantially oblong shape with round corners or an elliptical shape. the configuration of each of the pads 13 will be described in detail with reference to FIG. 3A and the following figures.

The vacuum path 14 is a suction route that extends from the respective pads 13 to a vacuum source 40. For example, as shown in FIG. 2, the vacuum path 14 is formed within the plate 12. As the wafer W is placed on the pads 13, the vacuum source 40 performs sucking through the vacuum path 14 and the wafer W is sucked to the pads 13. The vacuum path 14 may be formed in any position insofar as the vacuum path 14 enables the vacuum source 40 to perform sucking.

Examples of the shape of a warped wafer W includes a so-called “dome shape” in which the wafer W is gradually curving upward toward the center C, a so-called “bowl shape” in which the wafer W is gradually curving downward toward the center C, and a random shape in which the wafer W has the dome shape and the bowl shape in combination. However, in reality, it will be sufficient to assume that one of the “dome shape” and the “bowl shape” is generated in the local area of the wafer W on each of the pads 13. For that reason, the behavior of each of the pads 13 will now be described by taking, as an example, a case where the warped wafer W has the “dome shape” or the “bowl shape”.

That is to say, it can be said that the wafer W takes a warped shape having a deflection curve extending in a radial direction. In the respective embodiments including the present embodiment, even if the wafer W is warped, the pads 13 are made to conform to the wafer W, thereby reliably vacuum-sucking the wafer W.

Next, the configuration of each of the pads 13 according to the first embodiment will be described in detail. In the following description, among the pads 13 shown in FIG. 2, only the pad 13 surrounded by a closed curve P1 will be taken as a primary example.

FIG. 3A is a schematic plan view of the pad 13 according to the first embodiment. FIG. 3B is a schematic sectional view taken along line IIIB-IIIB′ in FIG. 3A. FIG. 3C is a schematic diagram illustrating the flexibility of the pad 13 according to the first embodiment.

As shown in FIG. 3A, the pad 13 includes a contact portion 13a, a major surface portion 13b and a suction hole 13c.

The contact portion 13a is a portion that makes contact with the wafer W as the target object to be sucked. The major surface portion 13b is a portion serving as a so-called base plate of the pad 13. The outer periphery of the major surface portion 13b is surrounded by the contact portion 13a. In the present embodiment, the major surface portion 13b has a substantially oblong shape with round corners as shown in FIG. 3A, but the shape of the major surface portion 13b is not limited thereto.

The suction hole 13c is formed in the central region of the major surface portion 13b. An inner space, which is surrounded by the contact portion 13a and which becomes a vacuum chamber when the contact portion 13a makes contact with the wafer W, is brought into communication with the vacuum source 40 through the suction hole 13c and a support body 15 to be described later (see FIG. 3D). Here, the inner space becomes the vacuum chamber by the operation of the vacuum source 40 in a state where the contact portion 13a makes contact with the wafer W.

As shown in FIG. 3B, the pad 13 includes a seal wall 13aa. The seal wall 13aa defines the inner space in cooperation with the major surface portion 13b when the contact portion 13a makes contact with the wafer W.

The pad 13 may be made of various kinds of materials such as a resin and the like. For example, it is preferred that the material of the pad 13 has flexibility in order for the pad 13 to conform to the deformation of the wafer W.

Since the pad 13 may make contact with a wafer W heated to a high temperature, it is preferred that the material of the pad 13 is superior in heat resistance. As one example, a polyimide resin or the like can be suitably used as the material of the pad 13. In the present embodiment, it is assumed that the pad 13 is one-piece molded through the use of a polyimide resin.

Thus, the pad 13 has such a property that it can be flexed as shown in FIG. 3C. An arrow 301 in FIG. 3C schematically illustrates the flexibility of the pad 13, but does not limit the bending direction of the pad 13.

Next, description will be made on an attachment structure of the pad 13. FIG. 3D is a schematic perspective view of a support body 15 according to the first embodiment. FIGS. 3E and 3F are schematic sectional views showing the attachment structure of the pad 13 according to the first embodiment, which are taken along the line IIIB-IIIB′ in FIG. 3A.

The support body 15 is a portion which is installed to the plate 12 to elastically support the pad 13. That is to say, the support body 15 is, e.g., an elastic body formed into a substantially annular shape as shown in FIG. 3D. The support body 15 is made of, e.g., a silicon resin, a rubber or the like. Further, the support body 15 has a greater elasticity than the pad 13.

As shown in FIG. 3E, a suction hole 12a communicating with the vacuum path 14 and an annular wall portion 12b are formed in the plate 12 in advance. That is to say, the plate 12 is a fixing base of the suction structure according to the present embodiment.

The support body 15 is installed in a space surrounded by the annular wall portion 12b of the plate 12. More specifically, the support body 15 is fixed such that the inner circumferential surface of the support body 15 surrounds the periphery of the suction hole 12a. The pad 13 is fixed to the support body 15 such that the inner circumferential surface of the support body 15 surrounds the periphery of the suction hole 13c. An adhesive agent or the like is used in fixing the support body 15 and the pad 13.

That is to say, the support body 15 seals up a gap between the suction holes 13c and 12a. Thus, as shown in FIG. 3F, the inner space 16 is formed by the pad 13 and the support body 15. The support body 15 supports the pad 13 from the bottom only at a portion around the periphery of the suction hole 13c. More specifically, the pad 13 is supported in a position of the pad around the periphery of the suction hole 13c.

In the present embodiment, there has been described an example where the annular wall portion 12b is formed in the plate 12 and the support body 15 is installed in the space surrounded by the annular wall portion 12b. Alternatively, the plate 12 may be depressed and the support body 15 may be installed on the surface of the plate 12 without forming the annular wall portion 12b.

Next, description will be made on an arrangement example of the pad 13. FIG. 3G is a schematic plan view showing the arrangement example of the pad 13 according to the first embodiment.

As shown in FIG. 3G, for example, the pad 13 is arranged such that the major axis direction of the pad 13 is substantially orthogonal to a radial direction of the wafer W located in the normal position, the radial direction extending through the center of the pad 13. In other words, the pad 13 is arranged such that the major axis of the pad is tangential to an imaginary circle drawn about the center C of the wafer W located in the normal position.

This enables the pad 13 to conform, in the minor axis direction thereof, to the wafer W having a warped shape, such as a dome shape or a bowl shape, in which the warp direction of the wafer W extends in the radial direction. More specifically, the warped amount of the wafer W is small in the direction substantially orthogonal to the radial direction of the wafer W but is large in the radial direction of the wafer W. Since the minor axis of the pad 13 extends along the radial direction of the wafer W, the warped amount of the wafer W on the pad 13 remains small. That is to say, the pad 13 can be made to conform to the warped wafer W without largely deforming the pad 13. Accordingly, a leakage is hard to occur in a vacuum-sucking process.

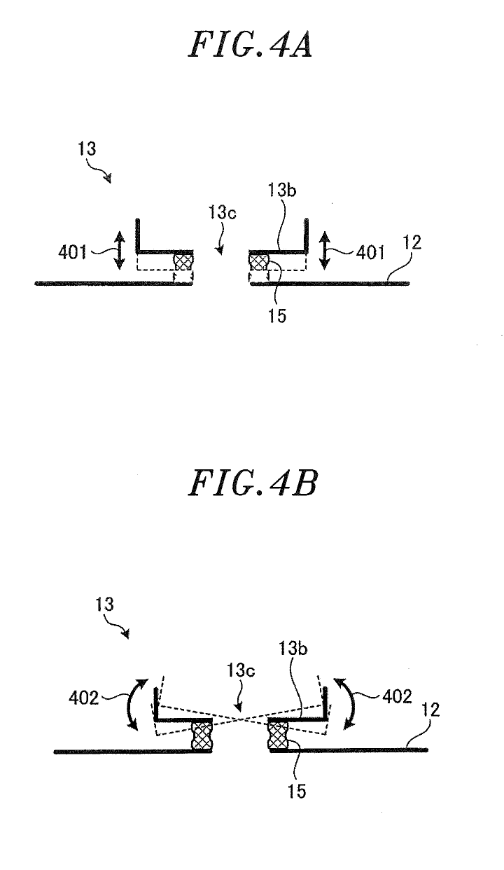

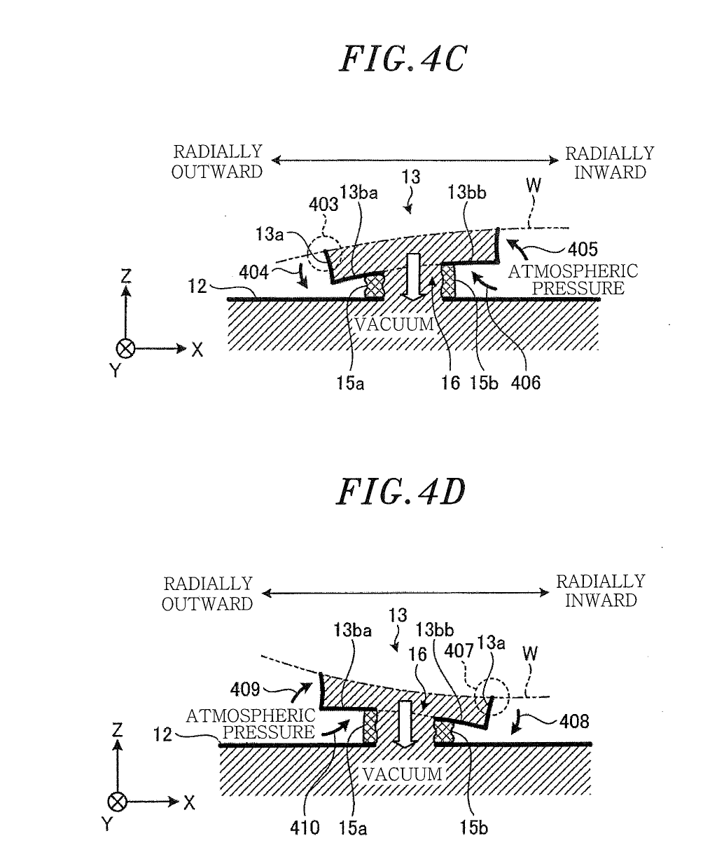

Next, the movement of the pad 13 according to the present embodiment will be described with reference to FIGS. 4A to 4D. FIGS. 4A to 4D are schematic diagrams showing the movement of the pad 13 according to the first embodiment.

In FIGS. 4A to 4D, for the sake of easy understanding, the pad 13 and its vicinities are shown in a simplified way and the movement of the pad 13 is illustrated in a more exaggerated form than the actual movement. This holds true in FIGS. 6A to 6D which will be used in describing the second embodiment later.

As described above, the pad 13 is elastically supported by the support body 15 as an elastic body only at the portion around the periphery of the suction hole 13c. Thus, as shown in FIG. 4A, the pad 13 can move up and down with respect to the plate 12 due to the deformation of the support body 15 (see an arrow 401 in FIG. 4A).

Moreover, as shown in FIG. 4B, the pad 13 can make tilting movement with respect to the plate 12 due to the deformation of the support body 15 (see an arrow 402 in FIG. 4B). The movements shown in FIGS. 4A and 4B may be combined in any direction.

That is to say, the elastic support of the support body 15 enables the pad 13 to easily conform to the warped wafer W. Since the support body 15 supports the pad 13 only at the portion around the periphery of the suction hole 13c, it is possible to widen the non-supported region in the major surface portion 13b of the pad 13.

That is to say, it is possible to increase the bendable region in the pad 13. This enables the pad 13 to be flexed to a great extent. In other words, the elasticity of the support body 15 and the flexibility of the pad 13 itself act in a synergistic way, thereby enabling the pad 13 to reliably conform to the warped wafer W.

Specific examples of the movement of the pad 13 are shown in FIGS. 4C and 4D. In the description made with reference to FIGS. 4C and 4D, the section of the major surface portion 13b of the pad 13 at the outer side in the radial direction of the wafer W will be referred to as an “outer section 13ba”. Similarly, the section of the major surface portion 13b of the pad 13 at the inner side in the radial direction of the wafer W will be referred to as an “inner section 13bb”.

The section of the support body 15 at the outer side in the radial direction of the wafer W will be referred to as a “support-body outer section 15a”. Similarly, the section of the support body 15 at the inner side in the radial direction of the wafer W will be referred to as a “support-body inner section 15b”.

As shown in FIG. 4C, it is assumed that the wafer W warped in a dome shape is sucked to the pad 13. In this case, the wafer W initially makes contact with the contact portion 13a at the side of the outer section 13ba (see a closed curve 403 in FIG. 4C), whereby the support-body outer section 15a is contracted and deformed by the weight of the wafer W. Thus, the outer section 13ba is tilted toward the plate 12 (see an arrow 404 in FIG. 4C). At this time, the outer section 13ba itself is also flexed.

Since the major surface portion 13b is one-piece molded, the inner section 13bb is lifted up toward the wafer W (see an arrow 405 in FIG. 4C) by the tilting movement of the outer section 13ba. At this time, the support-body inner section 15b is simultaneously extended and deformed.

The contact portion 13a at the side of the inner section 13bb makes contact with the wafer W to form the inner space 16 (see the hatched region in FIG. 4C).

If sucking is performed by the vacuum source 40 to make the inner space 16 have a negative pressure, the pad 13 is strongly pressed against the wafer W from below due to the pressure difference between the pressure of the inner space 16 and the atmospheric pressure (see an arrow 406 in FIG. 4C). Thus, even if the wafer W is warped in the dome shape, the pad 13 can conform to the wafer W and it is possible to reliably suck the wafer W.

As shown in FIG. 4D, it is assumed that the wafer W warped in a bowl shape is sucked to the pad 13. In this case, the wafer W initially makes contact with the contact portion 13a at the side of the inner section 13bb (see a closed curve 407 in FIG. 4D), whereby the support-body inner section 15b is contracted and deformed by the weight of the wafer W. Thus, the inner section 13bb is tilted toward the plate 12 (see an arrow 408 in FIG. 4D). At this time, the inner section 13bb itself is also flexed.

Since the major surface portion 13b is one-piece molded, the outer section 13ba is lifted up toward the wafer W (see an arrow 409 in FIG. 4D) by the tilting movement of the inner section 13bb. At this time, the support-body outer section 15a is simultaneously extended and deformed.

The contact portion 13a at the side of the outer section 13ba makes contact with the wafer W to form the inner space 16 (see the hatched region in FIG. 4D).

If sucking is performed by the vacuum source 40 to make the inner space 16 have a negative pressure, in the same manner as in the case of the wafer W warped in the dome shape, the pad 13 is strongly pressed against the wafer W from below due to the pressure difference between the pressure of the inner space 16 and the atmospheric pressure (see an arrow 410 in FIG. 4D). Thus, even if the wafer W is warped in the bowl shape, the pad 13 can conform to the wafer W and it is possible to reliably suck the wafer W.

As described above, the suction structure according to the first embodiment includes the fixing base (the plate), the pad, the support body, the inner space and the suction hole. The pad includes the contact portion that makes contact with the target object to be sucked. The support body is installed to the fixing base to elastically support the pad. The inner space is formed by the pad and the support body. The suction hole is provided in the fixing base to bring the inner space into communication with a vacuum source.

Accordingly, the suction structure according to the first embodiment can reliably suck a warped wafer W.

The foregoing description has been made by taking, as an example, a case where the pad is elastically supported from the bottom at the portion around the periphery of the suction hole. However, the pad may be elastically supported from the bottom at a portion around the outer periphery of the pad itself. This case will be described as the second embodiment with reference to FIGS. 5A to 6D.

### Second Embodiment

FIG. 5A is a schematic plan view of a pad 13A according to the second embodiment. FIG. 5B is a schematic sectional view taken along line VB-VB′ in FIG. 5A. In the second embodiment, description will be made mainly on the components differing from those of the first embodiment.

As shown in FIG. 5A, unlike the pad 13 of the first embodiment, the pad 13A of the second embodiment further includes a flange (brim) portion 13d that extends and protrudes from the outer periphery of the contact portion 13a in a brim-like shape.

As shown in FIG. 5B, the flange portion 13d is provided at the same height as the major surface portion 13b to continuously extend from the major surface portion 13b. The support body 15 is fixedly installed at a lower surface (rear surface) of the flange portion 13d to elastically support the pad 13A only at a portion around the outer periphery of the flange portion 13d. That is, the outer peripheral portion of the flange portion 13d is supported by the support body 15.

Next, the movement of the pad 13A according to the present embodiment will be described with reference to FIGS. 6A to 6D. FIGS. 6A to 6D are schematic diagrams showing the movement of the pad 13A according to the second embodiment.

As described above, the outer peripheral portion of the flange portion 13d of the pad 13A is supported by the support body 15, which is an elastic body. Thus, as shown in FIG. 6A, the pad 13A can move up and down with respect to the plate 12 due to the deformation of the support body 15 (see an arrow 601 in FIG. 6A).

Moreover, as shown in FIG. 6B, the pad 13A can make tilting movement with respect to the plate 12 due to the deformation of the support body 15 (see an arrow 602 in FIG. 6B). The movements shown in FIGS. 6A and 6B may be combined in any direction.

That is to say, the pad 13A can easily conform to the warped wafer W. Since the support body 15 supports only the outer peripheral portion of the flange portion 13d of the pad 13A, it is possible to increase the bendable region in the pad 13A.

Accordingly, as in the first embodiment, the elasticity of the support body 15 and the flexibility of the pad 13A itself act in a synergistic way, thereby enabling the pad 13A to reliably conform to the warped wafer W.

Specific examples of the movement of the pad 13A are shown in FIGS. 6C and 6D. As in the description made above with reference to FIGS. 4C and 4D, the “outer section 13ba”, the “inner section 13bb”, the “support-body outer section 15a” and the “support-body inner section 15b” are also used in the present embodiment. Moreover, each of the “outer section 13ba” and the “inner section 13bb” includes the flange portion 13d.

As shown in FIG. 6C, it is assumed that the wafer W warped in a dome shape is sucked to the pad 13A. In this case, the wafer W initially makes contact with the contact portion 13a at the side of the outer section 13ba (see a closed curve 603 in FIG. 6C), whereby the support-body outer section 15a is contracted and deformed by the weight of the wafer W. Thus, the outer section 13ba is tilted toward the plate 12 (see an arrow 604 in FIG. 6C). At this time, the outer section 13ba itself is also flexed.

Since the major surface portion 13b is one-piece molded, the inner section 13bb is lifted up toward the wafer W (see an arrow 605 in FIG. 6C) by the tilting movement of the outer section 13ba. At this time, the support-body inner section 15b is simultaneously extended and deformed.

The contact portion 13a at the side of the inner section 13bb makes contact with the wafer W to form the inner space 16 (see the hatched region in FIG. 6C).

If sucking is performed by the vacuum source 40 to make the inner space 16 have a negative pressure, the pad 13A and the wafer W are strongly pulled toward the inner space 16 due to the pressure difference between the pressure of the inner space 16 and the atmospheric pressure (see an arrow 606 in FIG. 6C). Thus, the wafer W is reliably sucked. That is to say, even if the wafer W is warped in the dome shape, the pad 13A can conform to the wafer W and it is possible to reliably suck the wafer W.

As shown in FIG. 6D, it is assumed that the wafer W warped in a bowl shape is sucked to the pad 13A. In this case, the wafer W initially makes contact with the contact portion 13a at the side of the inner section 13bb (see a closed curve 607 in FIG. 6D), whereby the support-body inner section 15b is contracted and deformed by the weight of the wafer W. Thus, the inner section 13bb is tilted toward the plate 12 (see an arrow 608 in FIG. 6D). At this time, the inner section 13bb itself is also flexed.

The outer section 13ba is lifted up toward the wafer W (see an arrow 609 in FIG. 6D) by the tilting movement of the inner section 13bb. At this time, the support-body outer section 15a is simultaneously extended and deformed.

The contact portion 13a at the side of the outer section 13ba makes contact with the wafer W to form the inner space 16 (see the hatched region in FIG. 6D).

If sucking is performed by the vacuum source 40 to make the inner space 16 have a negative pressure, in the same manner as in the case of the wafer W warped in the dome shape, the pad 13A and the wafer W are strongly pulled toward the inner space 16 due to the pressure difference between the pressure of the inner space 16 and the atmospheric pressure (see an arrow 610 in FIG. 6D). Thus, even if the wafer W is warped in the bowl shape, the pad 13A can conform to the wafer W and it is possible to reliably suck the wafer W.

Accordingly, the suction structure according to the second embodiment can reliably suck a warped wafer W.

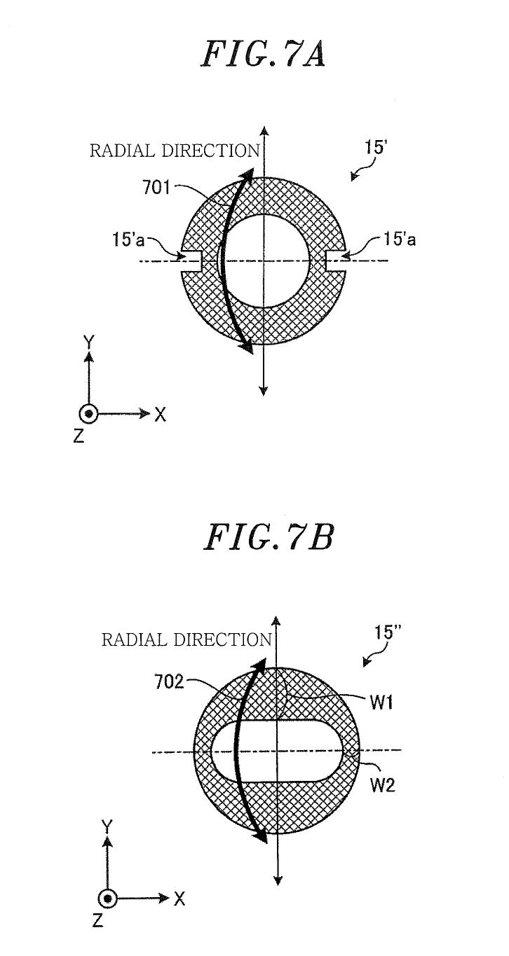

The shape of the support body is not limited to the above-described embodiments. Modified examples of the support body will now be described with reference to FIGS. 7A and 7B.

FIG. 7A is a schematic plan view of a support body 15′ according to a first modified example. FIG. 7B is a schematic plan view of a support body 15″ according to a second modified example.

As shown in FIG. 7A, the support body 15′ according to the first modified example includes notches 15′a which are formed in an outer peripheral portion of the support body 15′ along a direction substantially orthogonal to the radial direction of the wafer W located in the normal position. That is, the notches 15′a are arranged on the major axis of the pad 13. Thus, the support body 15′ is easily deformable in the radial direction of the wafer W (see an arrow 701 in FIG. 7A). Therefore, the pad 13 (the pad 13A) can easily conform to the wafer W warped in the radial direction thereof.

As shown in FIG. 7B, the support body 15″ according to the second modified example can be formed by, e.g., forming the outer periphery thereof into a substantially circular shape and forming the inner periphery thereof into an oblong shape with round corners or an elliptical shape. As shown in FIG. 7B, the support body 15″ is formed such that the width W1 (shortest distance) between the inner periphery and the outer periphery in the radial direction of the wafer W is larger than the width W2 (shortest distance) between the inner periphery and the outer periphery in the major axis direction.

Thus, the support body 15″ is easily deformable along the radial direction (see an arrow 702 in FIG. 7B). This enables the pad 13 (or the pad 13A) to easily conform to the wafer W warped along the radial direction thereof.

In the respective embodiments described above, description has been made by taking, as an example, a case where the pad is elastically supported at the lower side thereof. However, the pad may be elastically supported at the lateral side thereof. This case will be described as the third embodiment with reference to FIGS. 8A to 9.

### Third Embodiment

FIG. 8A is a schematic plan view of a pad 13B according to the third embodiment. FIGS. 8B and 8C are schematic sectional views taken along line VIIIB-VIIIB′ in FIG. 8A.

In the third embodiment, description will be made mainly on the components differing from those of the first and the second embodiment. The shape of the pad 13B is substantially identical with the shape of the pad 13A of the second embodiment.

As shown in FIG. 8A, the pad 13B according to the third embodiment includes a support body 15A that elastically supports the outer circumferential surface thereof at the lateral side.

More specifically, as shown in FIG. 8B, the support body 15A, on the inner circumferential surface of the annular wall portion 12b of the plate 12, elastically supports the outer circumferential surface of the pad 13B at the lateral side thereof. The support body 15A as a substantially annular elastic body is fixed to the plate 12 so as to surround the outer circumferential surface of the pad 13B. The support body 15A seals up a gap between the outer circumferential surface of the pad 13B and the inner circumferential surface of the annular wall portion 12b.

Thus, the annular wall portion 12b forms the inner space 16 in cooperation with the pad 13B and the wafer W. The inner space 16 communicates with the vacuum source 40 through the suction hole 12a of the plate 12.

As shown in FIG. 8B, the support body 15A supports the pad 13B while an interstice i is provided between the lateral lower end of the pad 13B (i.e., a lower end of the outer circumferential surface of the pad 13B) and a bottom surface of the plate 12 in the inner space 16.

The following effects can be obtained through the suction structure according to the third embodiment. Since the pad 13B is supported at the lateral side thereof, it is not necessary to restrict the movement of the pad 13B in the horizontal direction and there is no need to perform the positioning of the pad 13B.

In as much as the pad 13B is elastically supported by the support body 15A at the lateral side thereof while providing the interstice i, it is possible to enable the contact portion 13a to make smooth tilting movement not only in the horizontal direction but also in the vertical direction. This enables the pad 13B to reliably conform to the wafer W.

By providing the interstice i, the pad 13B holding the wafer W can move up and down with respect to the plate 12.

As shown in FIG. 8C, the suction structure may include a pad 13B′ in which the major surface portion 13b has a rear surface tapered toward the suction hole 13c.

Alternatively, the width of a specified region of the support body 15A may differ from the width of the other region. FIG. 9 is a schematic plan view of a pad 13B″ according to a modified example of the third embodiment. As shown in FIG. 9, the support body 15A′ supporting the pad 13B″ at the lateral side thereof includes the inner periphery and the outer periphery, and the width W3 (shortest distance) between the inner periphery and the outer periphery in the radial direction of the wafer W is larger than the width W4 (shortest distance) between the inner periphery and the outer periphery in the major axis direction of the pad 13B″.

Thus, the support body 15A′ is easily deformable along the radial direction of the wafer W. This enables the pad 13B″ to easily conform to the wafer W warped along the radial direction of the wafer W. That is to say, it is possible to reliably suck a warped wafer W.

As described above, the suction structure according to the third embodiment includes the fixing base (the plate), the pad, the annular wall portion, the suction hole and the support body. The pad includes a contact portion that makes contact with a target object to be sucked. The annular wall portion is provided in the fixing base to form the inner space in cooperation with the pad and the wafer. The suction hole is provided in the fixing base to bring the inner space into communication with the vacuum source. The support body, on the inner circumferential surface of the annular wall portion, elastically supports the outer circumferential surface of the pad at the lateral side thereof.

Accordingly, the suction structure according to the third embodiment can reliably suck a warped wafer W.

In the respective embodiments described above, there has been taken an example where the pad is made to easily conform to the wafer by allowing the elasticity of the support body and the flexibility of the pad to act in a synergistic way. Alternatively, it may be possible to use the elasticity of an adhesive agent. In this regard, description will be made with reference to FIG. 10.

FIG. 10 is a schematic diagram showing an elastic bonding layer 17. For example, as shown in FIG. 10, the elastic bonding layer 17 composed of an elastic adhesive agent or the like may be formed between the plate 12 and the support body 15 and between the support body 15 and the pad 13.

This makes it possible to use the elasticity of the elastic bonding layer 17 in addition to the elasticity of the support body 15 and the flexibility of the pad 13. Thus, the pad 13 can smoothly conform to the wafer W. Accordingly, it is possible to reliably suck a warped wafer W.

In the respective embodiments described above, there has been taken an example where the major surface portion of the pad has an oblong shape with round corners. The major surface portion may have a substantially oval shape including an oblong shape with round corners and an elliptical shape. However, the shape of the major surface portion is not limited to the substantially oval shape but may be a substantially circular shape or other shapes.

In the respective embodiments described above, there has been described a single-arm robot by way of example. However, the present disclosure may be applied to a dual-arm robot or multi-arm robots.

In the respective embodiments described above, there has been described an example where the target object is a wafer. However, the target object is not limited thereto but may be any thin substrate. In this regard, the kind of the substrate does not matter. The substrate may be, e.g., a glass substrate for a liquid crystal panel display.

In case of the glass substrate, the aforementioned radial direction refers to a radial direction of an imaginary circle drawn about the center of the target object or a direction radially extending from the center of the target object.

The target object may not be a substrate as long as it is a thin workpiece.

In the respective embodiments described above, description has been made by taking, as an example, a case where the robot is a substrate transfer robot for transferring a substrate such as a wafer or the like. However, the robot may be a robot for performing a work other than a transfer work. For example, the robot may be an assembling robot that performs a specified assembling work while vacuum-sucking a thin workpiece through the use of a hand provided with a suction structure.

The number of robot arms, the number of robot hands and the number of axes are not limited by the respective embodiments described above.

It should be understood by those skilled in the art that various modifications, combinations, sub-combinations and alterations may occur depending on design requirements and other factors insofar as they are within the scope of the appended claims or the equivalents thereof.

What is claimed is:

1. A suction structure, comprising:
a fixing base including an annular wall portion;
a pad including a contact portion which makes contact with a target object to be sucked; and
a support body, which is installed on an inner circumferential surface of the annular wall portion and configured to elastically support an outer circumferential surface of the pad at a lateral side of the pad,
wherein the pad and the support body define an inner space, and the fixing base includes a suction hole which brings the inner space into communication with a vacuum source.

2. The suction structure of claim 1, wherein the support body is an elastic body formed into a substantially annular shape and is fixedly installed to the fixing base so as to surround the outer circumferential surface of the pad, and
wherein a gap between the outer circumferential surface of the pad and the inner circumferential surface of the annular wall portion is sealed by the support body.

3. The suction structure of claim 1, wherein the support body supports the pad while an interstice is provided between a lower end of the outer circumferential surface of the pad and a bottom surface of the fixing base in the inner space.

4. The suction structure of claim 2, wherein the support body supports the pad while an interstice is provided between a lower end of the outer circumferential surface of the pad and a bottom surface of the fixing base in the inner space.

5. The suction structure of claim 1, wherein the pad is formed into a substantially oval shape and is arranged such that a major axis direction of the pad is substantially orthogonal to a radial direction of an imaginary circle drawn about the center of the target object in a normal position.

6. The suction structure of claim 2, wherein the pad is formed into a substantially oval shape and is arranged such that a major axis direction of the pad is substantially orthogonal to a radial direction of an imaginary circle drawn about the center of the target object in a normal position.

7. The suction structure of claim 3, wherein the pad is formed into a substantially oval shape and is arranged such that a major axis direction of the pad is substantially orthogonal to a radial direction of an imaginary circle drawn about the center of the target object in a normal position.

8. The suction structure of claim 4, wherein the pad is formed into a substantially oval shape and is arranged such that a major axis direction of the pad is substantially orthogonal to a radial direction of an imaginary circle drawn about the center of the target object in a normal position.

9. The suction structure of claim 5, wherein the support body is formed into a substantially annular shape having an inner periphery and an outer periphery, and a width between the inner periphery and the outer periphery in the radial direction is larger than a width between the inner periphery and the outer periphery in the major axis direction.

10. The suction structure of claim 7, wherein the support body is formed into a substantially annular shape having an inner periphery and an outer periphery, and a width between the inner periphery and the outer periphery in the radial direction is larger than a width between the inner periphery and the outer periphery in the major axis direction.

11. The suction structure of claim 1, wherein, when the target object comes into contact with the contact portion, the internal space becomes a vacuum state by an operation of the vacuum source.

12. A robot hand comprising the suction structure described in claim 1.

13. A robot comprising the robot hand described in claim 12.
